(19) United States
(12) Patent Application Publication
(10) Pub. No.: US 2010/0043921 A1
(43) Pub. Date: Feb. 25, 2010

(54) CUTTER HEAD ASSEMBLY FOR A WOOD PLANING MACHINE

(76) Inventor: Chin-Yuan LIU, Taichung City (TW)

Correspondence Address: FOLEY AND LARDNER LLP;SUITE 500, 3000 K STREET NW, WASHINGTON, DC, 20007, US

(21) Appl. No.: 12/470,240

(22) Filed: May 21, 2009

Related U.S. Application Data
(63) Continuation-in-part of application No. 12/197,914, filed on Aug. 25, 2008.

(51) Int. Cl. B27G 13/04

(52) U.S. Cl. 144/117.1; 144/236

(57) ABSTRACT

A cutter head assembly for a wood planing machine includes a rotary shaft, a plurality of blade carriers non-rotatably retained on the shaft, and a plurality of cutter blades respectively secured on outer wall surfaces of the blade carriers by means of a plurality of screw fasteners. The outer wall surface of each blade carrier includes a leading region and a trailing region that form a first included angle of at least 90 degrees therebetween. Each blade has a first major wall surface abutting against the leading region, a second major wall surface disposed opposite to the first major wall surface, a cutting edge interposed between the first and second major wall surfaces and extending beyond the outer wall surface of the respective blade carrier, and an abutting edge disposed opposite to the cutting edge to abut against the trailing region. The cutting edge of each cutter blade intersects the second major wall surface at a second included angle ranging from 35 degrees to 45 degrees.

### CROSS-REFERENCE TO RELATED APPLICATION

This application is a continuation-in-part of U.S. patent application Ser. No. 12/197,914, filed by the applicant on Aug. 25, 2008, the entire disclosure of which is incorporated herein by reference.

### BACKGROUND OF THE INVENTION

1. Field of the Invention

This invention relates to a cutter head assembly for a wood planing machine, more particularly to a cutter head assembly having a plurality of cutting blades for mounting on a rotary shaft of a wood planing machine so as to obtain a spiral cutting contour.

2. Description of the Related Art

Referring to FIGS. 1 and 2, in co-pending U.S. patent application Ser. No. 12/197,914, the applicant disclosed a cutter head assembly for a wood planing machine that includes a rotary shaft 1, a plurality of blade carriers 2 non-rotatably sleeved on the shaft 1, and a plurality of cutter blades 3 secured to the blade carriers 2 and arranged in a spiral manner. An outer wall surface of each blade carrier 2 includes a leading region 21 and a trailing region 22, which form an obtuse included angle (θ1) therebetween. Each cutter blade 3 is made from tungsten steel material, and includes a first major wall surface 31 configured to abut against the leading region 21, a second major wall surface 32 opposite to the first major wall surface 31, and four flat edges 33 interposed between the first and second major wall surfaces 31,32. One of the flat edges 33 is configured to abut against the trailing region 22, and an opposite one of the flat edges 33 serves as a cutting edge for working on a workpiece (A). The cutting edge 33 intersects the second major wall surface 32 at an acute included angle (θ2), and forms an included angle (θa) with a rotary axis of the shaft 1.

Since the cutter blades 3 are made from tungsten steel material with good toughness and high hardness, the included angle (θa) is limited to be within the range of 17 to 20 degrees when the cutter blades 3 are mounted on the wood planing machine, such as a 13″, 16″ or 20″ planing machine, and the included angle (θ2) is configured to be not less than 53 degrees in order to prevent breakage of the cutter blades 3 during a planing operation. However, such configurations of the cutter blades 3 result in relatively heavy load on a power motor of the wood planing machine.

Furthermore, although the cutter head assembly of the aforementioned patent application can be modularized to facilitate manufacture, due to the obtuse included angle (θ1) between the leading region 21 and the trailing region 22, undesired displacement of the cutter blades 3 might occur when the cutter blades 3 are subjected to a relatively large impact force during a planing operation.

### SUMMARY OF THE INVENTION

An object of the present invention is to provide a cutter head assembly for a wood planing machine which has improved cutter blades to minimize the load on a power motor of the wood planing machine.

According to this invention, the cutter head assembly for a wood planing machine includes a rotary shaft elongated along and rotatable about an axis, a plurality of blade carriers which are sleeved on and which are non-rotatably retained on the shaft along the axis, a plurality of cutter blades disposed to be secured on outer wall surfaces of the blade carriers, respectively, and a plurality of screw fasteners.

The outer wall surface of each blade carrier includes a leading region and a trailing region that form a first included angle of at least 90 degrees therebetween. Each blade has a first major wall surface which has a first periphery and which is configured to abut against the leading region, a second major wall surface which is disposed opposite to the first major wall surface in a direction radial to the axis and which has a second periphery, a cutting edge which extends to join the first and second peripheries, and which extends beyond the outer wall surface of the respective blade carrier, and an abutting edge which is disposed opposite to the cutting edge and which is configured to abut against the trailing region. Each screw fastener is disposed to extend from the second major wall surface through the first major wall surface in the radial direction to threadedly engage the respective blade carrier. The cutting edge of each cutter blade intersects the second major wall surface at a second included angle ranging from 35 degrees to 45 degrees.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a cutter head assembly for a wood planing machine in co-pending U.S. application Ser. No. 12/197,914;

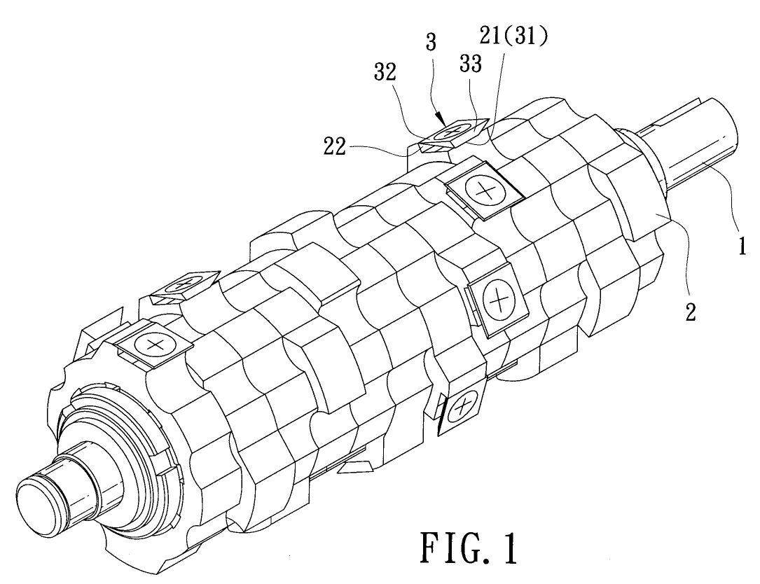

FIG. 2 is a schematic view illustrating a cutter blade mounted on a blade carrier in co-pending U.S. application Ser. No. 12/197,914;

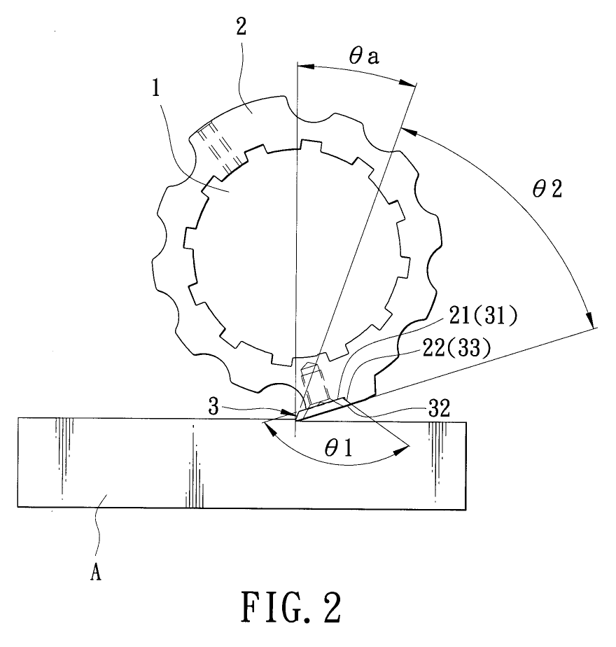

FIG. 3 is a schematic side view of the first preferred embodiment of a cutter blade of a cutter head assembly according to this invention;

FIG. 4 is a schematic view of the first preferred embodiment;

FIG. 5 is a fragmentary side view of the second preferred embodiment of a cutter blade of a cutter head assembly according to this invention; and

FIG. 6 is a fragmentary view of the third preferred embodiment of a cutter head assembly according to this invention.

### DETAILED DESCRIPTION OF THE PREFERRED EMBODIMENTS

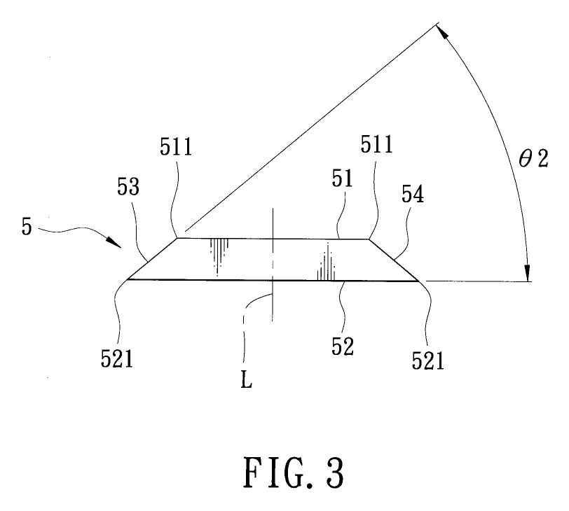

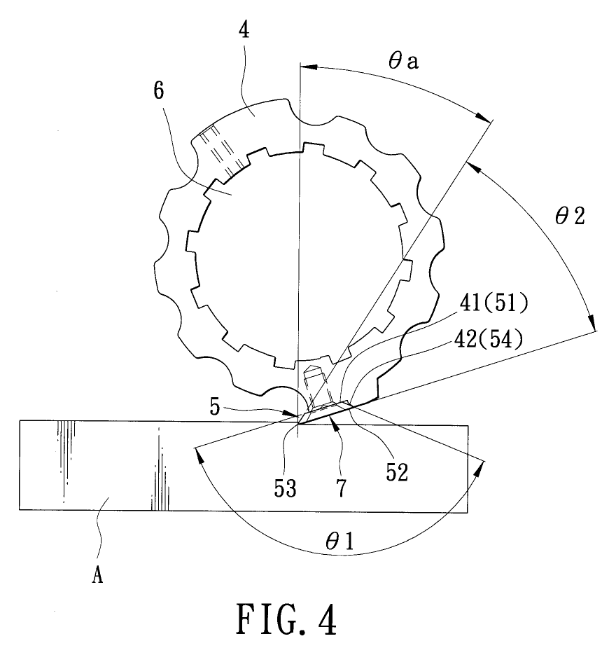

Referring to FIGS. 3 and 4, the preferred embodiment of a cutter head assembly for a wood planing machine according to the present invention is shown to comprise a rotary shaft 6, a plurality of blade carriers 4, a plurality of cutter blades 5, and a plurality of screw fasteners 7.

The rotary shaft 6 is elongated along and is rotatable about an axis. The blade carriers 4 are sleeved on and are non-rotatably retained on the shaft 6 along the axis. Each of the blade carriers 4 has an outer wall surface which includes a leading region 41 and a trailing region 42, which form a first included angle (θ1) therebetween. In this embodiment, the first included angle (θ1) is an obtuse angle. The cutter blades 5 are disposed to be secured on the outer wall surfaces of the blade carriers 4, respectively. Each of the cutter blades 5 has a first major wall surface 51 which has a first periphery and which is configured to abut against the leading region 41 of the respective blade carrier 4, and a second major wall surface 52 which is disposed opposite to the first major wall surface 51 in a direction radial to the axis, and which has a second periphery. Each of the screw fasteners 7 is disposed to extend from the second major wall surface 52 through the first major wall surface 51 of the respective cutter blade 5 in the radial direction, and to threadedly engage the respective blade carrier 4.

In this embodiment, the first major wall surface 51 is of rectangular shape, and has two pairs of parallel first side segments 511 serving as the first periphery. The second major wall surface 52 is of rectangular shape, is larger than the first major wall surface 51, and has two pairs of parallel second side segments 521 serving as the second periphery. Each of the cutter blades 5 has cutting and abutting edges 53,54 that respectively extend to join the parallel first side segments 511 of one pair respectively and the parallel second side segments 521 of a corresponding pair. In this embodiment, the cutting and abutting edges 53, 54 are symmetrical to each other with respect to a central line (L) of the cutting blade 5. The abutting edge 54 is configured to abut against the trailing region 42 such that the cutting edge 53 extends beyond the outer wall surface of the corresponding blade carrier 4 for working on a workpiece (A). The cutting edge 53 intersects the second major wall surface 52 at a second included angle (θ2).

Preferably, each of the cutter blades 5 is made from high-speed steel, and the second included angle (θ2) ranges from 35 degrees to 45 degrees.

When the cutter head assembly of this embodiment is used with a 13″, 16″ or 20″ wood planing machine, the cutting edge 53 forms with the axis of the shaft 6 an included angle (θa) ranging from 30 to 33 degrees.

As illustrated in the following table, when each cutter blade is 14 mm×14 mm×2 mm in size, the unloaded current of the cutter head assembly is 6.45 Å, the workpiece (A) to be planed is 600 mm (L)×8″ (W) in size, and the preset cutting amount is 2 mm, the loaded currents required in the present invention in which the cutter blades 5 are made from high-speed steel and the second included angle (θ2) is configured to be 45′, 40′ and 35′, are comparatively lowered that those required in the aforementioned U.S. patent application in which the cutter blades 3 are made from tungsten-steel and the second included angle (θ2) is configured to be 53°.

| θ2 = 53° | θ2 = 45° | θ2 = 40° | θ2 = 35° |
|---|---|---|---|
| tungsten | high-speed | high-speed | high-speed |
| steel | steel | steel | steel |
| 12.3 A | 11.7 A | 9.7 A | 9.2 A |
| 12.2 A | 11.8 A | 9.8 A | 9.3 A |
| 12.2 A | 11.8 A | 9.8 A | 9.3 A |
| 12.1 A | 11.6 A | 9.6 A | 9.1 A |
| 12.3 A | 11.6 A | 9.6 A | 9.1 A |
| 12.3 A | 11.8 A | 9.8 A | 9.3 A |
| 12.2 A | 11.7 A | 9.7 A | 9.2 A |
| 12.2 A | 11.7 A | 9.7 A | 9.3 A |
| 12.1 A | 11.8 A | 9.8 A | 9.3 A |
| 12.1 A | 11.8 A | 9.8 A | 9.1 A |
| 12.2 A | 11.6 A | 9.6 A | 9.2 A |
| 12.3 A | 11.7 A | 9.7 A | 9.2 A |

It is evident from the above table that the smaller the second included angle (θ2), the smaller will be the amount of loaded currents of the power motor.

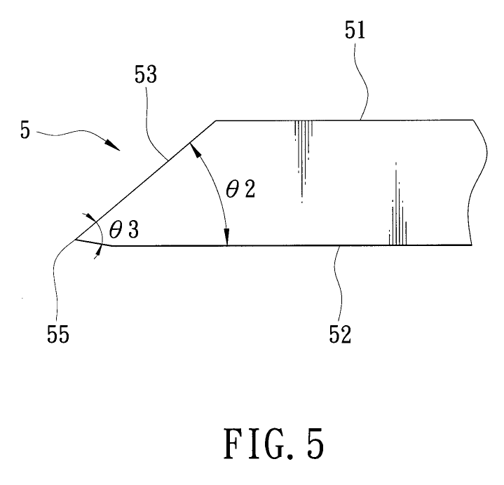

Referring to FIG. 5, the second preferred embodiment of a cutter head assembly according to this invention is similar to the first embodiment in construction. The second major surface 52 of each cutter blade 5 is further configured to incline gradually toward the cutting edge 53 so as to cooperatively form with the cutting edge 53 a tip end 55 that has a third included angle (θ3) larger than the second included angle (θ2). The third included angle (θ3) is larger than the second included angle (θ2) by 12 degrees or less. Due to the third included angle (θ3) of the tip end 55, wear and deformation of the cutter blades 5 is reduced, thereby prolonging the service life of the cutter blades 5.

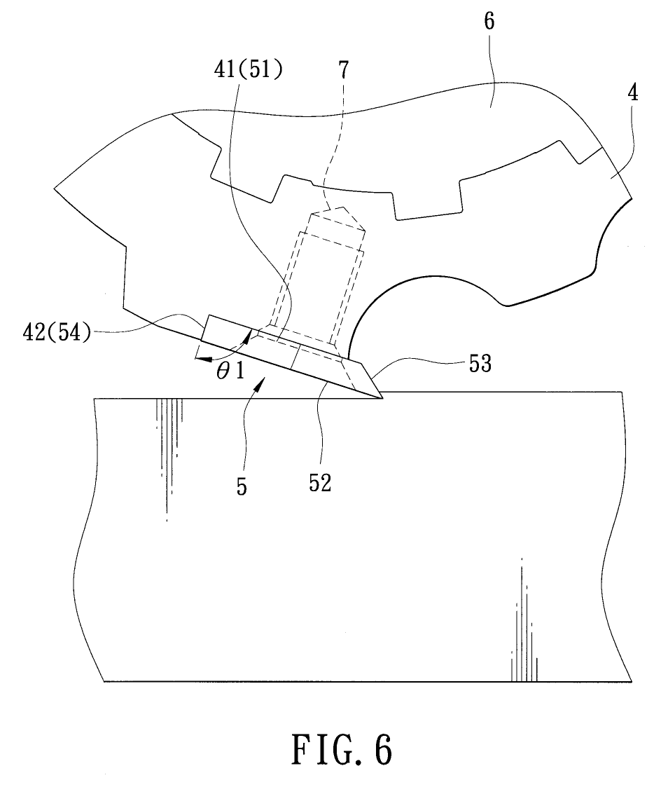

Referring to FIG. 6, the third preferred embodiment of a cutter head assembly according to this invention is similar to the first embodiment in construction, except that the first included angle (θ1) is 90 degrees so that the abutting edge 54 is disposed perpendicular to both the first and second major wall surfaces 51,52. The leading and trailing regions 41,42 are also perpendicular to each other.

As illustrated, since each of the cutter blades 5 is made from high-speed steel with relatively good ductility, and can have a relatively small second included angle (θ2), the cutting operation is smooth and the loaded current of the power motor of the planing machine is reduced.

Moreover, since the abutting edge 54 is configured to be perpendicular to the first and second major wall surfaces 51,52, the leading and trailing regions 41,42 can be configured to be perpendicular to each other, so that the cutter blades 5 can be firmly secured and supported on the cutter carriers 4. Cutting operations of the cutter head assembly can be conducted in a steady manner.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A cutter head assembly for a wood planing machine, comprising:
a rotary shaft which is elongated along and rotatable about an axis;
a plurality of blade carriers which are sleeved on and which are non-rotatably retained on said shaft along the axis, each of said blade carriers having an outer wall surface that includes a leading region and a trailing region, which form a first included angle of at least 90 degrees therebetween;
a plurality of cutter blades disposed to be secured on said outer wall surfaces of said blade carriers, respectively, each of said blades having
a first major wall surface which has a first periphery and which is configured to abut against said leading region,
a second major wall surface which is disposed opposite to said first major wall surface in a direction radial to the axis, and which has a second periphery,
a cutting edge which extends to join said first and second peripheries, and which extends beyond said outer wall surface of a respective one of said blade carriers, said cutting edge intersecting said second major wall surface at a second included angle ranging from 35 degrees to 45 degrees, and
an abutting edge which is disposed opposite to said cutting edge and which is configured to abut against said trailing region; and
a plurality of screw fasteners, each disposed to extend from said second major wall surface through said first major wall surface in the radial direction, and to threadedly engage the respective one of said blade carriers.

2. The cutter head assembly according to claim 1, wherein each of said cutter blades is made from high-speed steel.

3. The cutter head assembly according to claim 1, wherein said first major wall surface is of rectangular shape and has two pairs of parallel first side segments serving as said first periphery, said second major wall surface being of rectangular shape and having two pairs of parallel second side segments serving as said second periphery, said cutting and abutting edges respectively extending to join said parallel first side segments of one pair and said parallel second side segments of a corresponding pair.

4. The cutter head assembly according to claim 3, wherein said cutting and abutting edges are symmetrical to each other with respect to a central line of a respective one of said cutting blades.

5. The cutter head assembly according to claim 3, wherein the first included angle between said leading and trailing regions is 90 degrees such that said abutting edge is disposed perpendicular to said first major wall surface.

6. The cutter head assembly according to claim 1, wherein said second major surface is configured to incline gradually toward said cutting edge so as to cooperatively form with said cutting edge a tip end which has a third included angle larger than the second included angle.

7. The cutter head assembly according to claim 6, wherein said third included angle is larger than the second included angle by 12 degrees or less.
